(19) United States
(12) Patent Application Publication
(10) Pub. No.: US 2007/0024871 A1
(43) Pub. Date: Feb. 1, 2007

(54) Method and apparatus for measuring thickness of thin films via transient thermoreflectance

(76) Inventor: Alexei Maznev, Natick, MA (US)

Correspondence Address: PHILIPS INTELLECTUAL PROPERTY & STANDARDS, P.O. BOX 3001, BRIARCLIFF MANOR, NY, 10510, US

(21) Appl. No.: 10/548,345

(22) PCT Filed: Dec. 10, 2003
(86) PCT No.: PCT/IB03/05882

§ 371 Date: Sep. 7, 2005

Related U.S. Application Data
(60) Provisional application No. 60/433,367, filed on Dec. 13, 2002.

(51) Int. Cl. G01B 11/28

(52) U.S. Cl. 356/630; 356/432

(57) ABSTRACT

A method for measuring the thickness of a film is based on monitoring a transient change of the reflectivity of the film following an impulsive heating. The method includes the steps of impulsively irradiating a surface of the film with an excitation pulse to cause a rise in temperature in the film; irradiating the surface of the film with a probe beam, such that it reflects off the surface of the film to generate a reflected probe beam; detecting a time-dependent variation in intensity of the reflected probe beam; generating a signal waveform based on the measured variations in intensity; and determining the thickness of the film based on the signal waveform.

The invention relates to the field of optical metrology to determine properties of a sample, e.g., a thin film.

Fabrication of microelectronic devices typically includes deposition and patterning of multiple metal and dielectric layers. Optical techniques of film thickness measurement are most suited for industrial process control because they are typically fast, non-contact and non-destructive. However, optical measurement of metal film thickness is a challenging problem because metal films are typically opaque.

An optical measurement called thermal wave detection has been used previously to measure a variety of different material properties of a sample, such as film thickness. In thermal wave detection measurements, a periodically modulated excitation beam heats a sample. Measuring intensity variations of a reflected probe beam monitors periodic temperature changes at the film surface. The magnitude and/or phase of the measured intensity variations are then used to determine properties of a sample. This method is shown, for example in U.S. Pat. No. 5,978,074 entitled APPARATUS FOR EVALUATING METALIZED LAYERS ON SEMICONDUCTORS herein incorporated by reference. A similar method utilizing a low modulation frequency and only measuring the magnitude of the probe beam intensity variations is described in U.S. Pat. No. 6,054,868 entitled APPARATUS AND METHOD FOR MEASURING A PROPERTY OF A LAYER IN A MULTILAYERED STRUCTURE and incorporated herein by reference.

Another prior art optical technique called transient thermoreflectance utilizes a short (typically, femtosecond or picosecond) excitation laser pulse to impulsively heat up the surface of a sample, while the intensity of reflected probe pulse is measured to monitor the surface temperature dynamics. The probe pulse (typically, also a femtosecond or picosecond pulse) is delayed with respect to the excitation, and the measurement is repeated many times with variable delay in order to obtain the time dependence of the reflectivity. This technique is described e.g. in . C. A. Paddock and G. L. Eesley, “Transient thermoreflectance from thin metal films,” J. Appl. Phys. 60, 285 (1986).

U.S. Pat. No. 5,748,317, entitled APPARATUS AND METHOD FOR CHARACTERIZING THIN FILM AND INTERFACES USING AN OPTICAL HEAT GENERATOR AND DETECTOR, (the contents of which are herein incorporated by reference) proposes a method of measuring thermal properties of the film-substrate interface by analyzing transient thermoreflectance measurements. However, transient thermoreflectance technique has not been used for film thickness measurements. This is because, as it will be shown below, the relevant time scale of the temperature dynamics sensitive to the film thickness is typically in the range of tens of nanoseconds i.e., not accessible with a typical femtosecond apparatus used for transient thermoreflectance measurements. In one study, “Time-resolved thermoreflectivity of thin gold films and its dependence on film thickness”, J. Hohlfeld, J. G. Müller, S.-S. Wellershoff and E. Matthias, it has been found that the transient thermoreflectivity of thin gold films on the time scale of 10 ps is sensitive to the film thickness. Measurement described by Hohlfeld et al. could, in principle, be used for film thickness measurements. However, such measurements require a complicated femtosecond apparatus, and, as follows from FIG. 3 of the paper by Hohlfeld et al., would only be applicable for films thinner than 300 nm.

Accordingly, it would be desirable to provide a method and apparatus for quickly and simply measuring the properties of a sample, such as film thickness, that does not suffer from the prior art limitations.

The present invention meets the need for a simple method for film thickness measurement that would allow fast and reproducible measurements of metal films for semiconductor manufacturing process control in one aspect. The method includes the steps of impulsively irradiating a surface of the film with an excitation pulse to cause a rise in temperature in the film; irradiating the surface of the film with a probe beam, such that it reflects off the surface of the film to generate a reflected probe beam; detecting a series of variations in intensity of the reflected probe beam; generating a signal waveform based on the measured variations in intensity; and determining the thickness of the film based on the signal waveform.

In one embodiment of the invention, the step of irradiating the surface of the film with a probe beam is performed using continuous irradiation. In another embodiment of the invention, the step of irradiating the surface of the film with a probe beam is performed using quasi-continuous irradiation.

In another embodiment of the invention, the detecting step includes detecting variations that form a time domain temperature response to the excitation pulse.

In another embodiment of the invention, the determining step includes analyzing the signal waveform with a mathematical model. In another embodiment, the mathematical model is derived based upon the optical constants of the film and thermal properties of the material or materials of which the film is comprised.

In still another embodiment, the determining step includes analyzing the signal waveform with an empirical calibration. In another embodiment of the invention, the measuring and generating steps are performed by a high-speed detector and a transient digitizer, e.g. an oscilloscope.

In still another embodiment, the step of impulsively irradiating a surface of the film with an excitation pulse uses an excitation spot size greater than 10 μm.

In another embodiment, the method measures a patterned metal/dielectric structure with the feature size either larger or smaller than the excitation or probe spot size.

In another embodiment, the method measures an isolated metal structure either larger or smaller than a spot size of the excitation pulse.

In another aspect, the invention includes an apparatus for measuring the thickness of a film including a single irradiating means for irradiating a single impulsive excitation beam to cause a rise in temperature in the film; irradiating means for irradiating the surface of the film with a probe beam, such that it reflects off the surface of the film to generate a reflected probe beam; a high speed photodetector for detecting and measuring a series of variations in intensity of the reflected probe beam corresponding to variations in thermal decay within the surface of the thin film; an oscilloscope for generating a signal waveform based on the measured variations in intensity; and a microcomputer for determining the thickness of the film based on the signal waveform.

In one embodiment, the irradiating means for irradiating a single impulsive excitation beam is a laser.

In another embodiment, the irradiating means for irradiating the surface of the film with a continuous probe beam is a laser.

The invention provides many advantages that are evident from the following description, drawings, and claims.

The invention may be more completely understood in reference to the following figures:

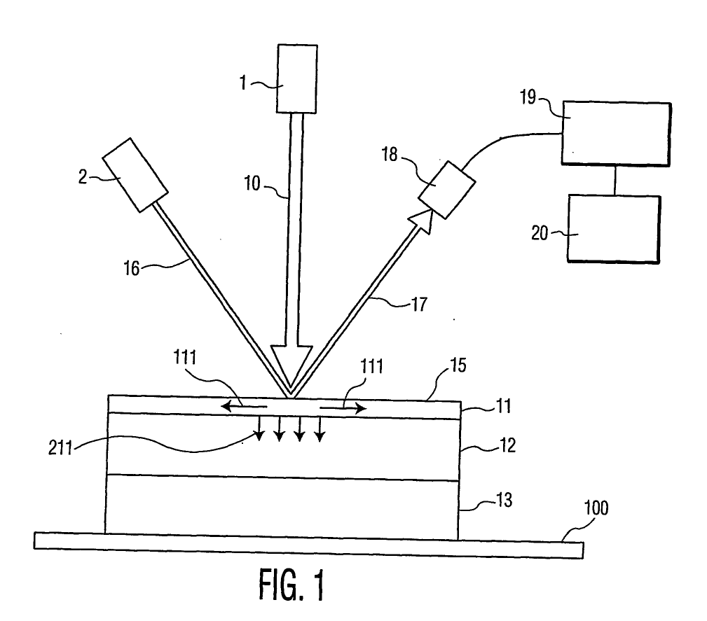

FIG. 1 depicts an apparatus for performing the method of measuring thin films according to the invention;

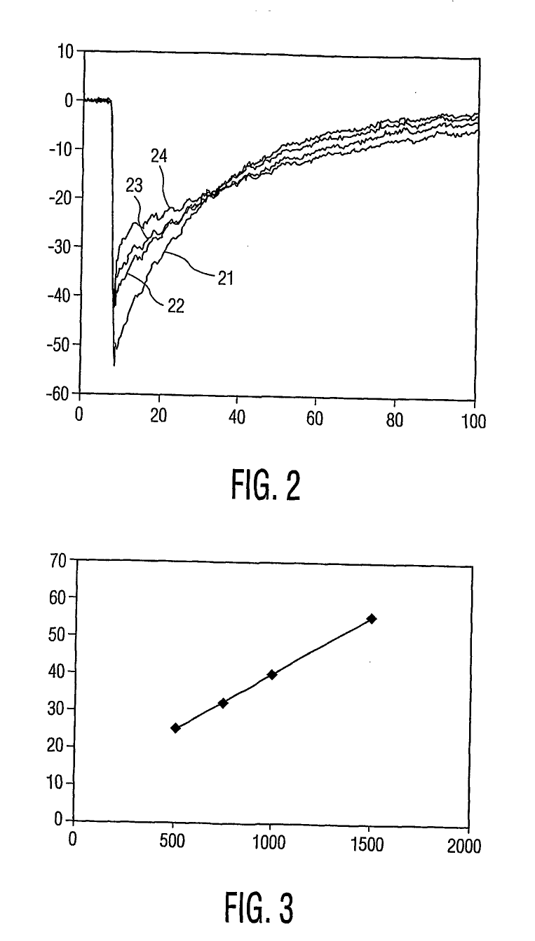

FIG. 2 depicts a chart of transient thermoreflectance signals obtained from 500, 750, 1000, and 1500 angstroms thickness of TiN deposited on a 1000 angstroms thick thermal oxide on silicon wafer; and

FIG. 3 depicts a chart showing effective decay time measured by fitting data in FIG. 2 to an exponential function versus the film thickness.

FIG. 1 depicts an apparatus for carrying out the method of measuring thin film thickness according to the invention. In the proposed method, an excitation laser pulse 10, emitted by an excitation laser 1, with a duration of ˜1 ns or shorter, is incident onto a surface 15 of a metal film 11. Metal film 11 is deposited over a layer of dielectric 12 on a silicon wafer 13. Platform 100 supports waver 13. Absorption of the optical radiation from laser pulse 10 at the surface 15 causes a temperature rise. This rise is followed by a decay caused by thermal diffusion. As described below, the dynamics of this decay depends on the thickness of film 11. Qualitatively, the thicker the film, the longer it takes to cool it down.

Probe laser beam 16, emitted by the probe laser 2, monitors the temperature dynamics. The probe beam 16 overlaps the excitation beam 10 at the sample surface 15. Probe beam 16 can be a continuous beam or a quasi-continuous beam. The latter term means a beam which is continuous on the time scale of a measurement i.e. typically from tens of nanoseconds to microseconds. An example of a quasi-continuous beam would be a beam modulated by rectangular pulses of 100 □s in duration. The intensity of the reflected portion 17 of the probe beam 16 undergoes intensity variations corresponding to temperature variations at the sample surface. This is due to the dependence of the optical constants of the film material on temperature. The reflected probe beam 17 intensity is measured by a high-speed detector 18 connected to oscilloscope 19, with frequency bandwidth of ˜500 MHz or higher. If needed, the detector 18 response can be averaged over multiple excitation pulses 10. A computer 20 analyzes a signal waveform generated by detector 18 and oscilloscope 19 to determine the thickness of the film 11.

Theoretical Estimates

The analysis below is based on a simple estimate for the length of thermal diffusion for time t,
L˜(χ^{t})^{1/2}, (1)
where χ is the thermal diffusivity.

The fastest process happening upon the absorption of the excitation pulse 10 is the heat transfer across the film 11 thickness. According to equation (1), a characteristic thermal diffusion time through the thickness of the metal film hₘ is given by
τ₁˜hₘ²/χₘ, (2)
where χₘ is the thermal diffusivity of the metal film. This time is ˜10 ns for 1 □m-thick Cu film. For a 0.1 μm-thick Cu film, equation (1) yields τ₁˜1 ns. However, in this case, the classical thermal diffusion model is not valid because 0.1 μm is about the length of the nonequilibrium diffusion length for photoexcited electrons in Cu. This nonequilibrium diffusion is a very fast process taking less than 1 ps (see e.g. O. B. Wright and. V. E. Gusev, IEEE Trans. Ultrason. 42, 331 (1995)). Thus for a Cu film of ˜0.1 □m or thinner, the thermal equlibrium across the film thickness is achieved almost instantaneously compared to the laser pulse duration of ˜0.5 ns.

After the thermal equlibrium across the film 11 thickness is established, the film 11 will cool down via two channels of heat transfer: lateral heat transport 111 within the plane of the film and vertical heat transfer 211 into the underlying dielectric 12. According to equation (1), for lateral heat transport 111, the characteristic radius of the heat propagation R will be given by
R˜a+(χₘ^{t})^{1/2}, (3)

Where a is the excitation pulse 10 spot size. Due to the energy conservation requirement, the temperature should be inversely proportional to the area over which the heat has diffused. Consequently, the temperature decay will be approximately described by

$$T ( t ) \sim \frac{{a}^{2}}{{R}^{2}} {T}_{0} = \frac{{T}_{0}}{1 + 2 \frac{\sqrt{{χ}_{m} t}}{a} + \frac{{χ}_{m} t}{{a}^{2}}} , \qquad ( 4 )$$

where T₀ is the initial temperature rise. The time needed for the temperature to decay by a factor of two will be given by
τ₂˜0.17a²/χₘ, (5)
At t>>τ₂ the temperature will decay as 1/t.

For the vertical heat transport 211, first consider the case when the dielectric 12 is much thicker than the metal film 11. If L is the length of thermal diffusion into the dielectric 12, then conservation of energy leads to the following equation for the temperature decay:

$$T ( t ) \sim \frac{{h}_{m} {ρ}_{m} {c}_{m}}{{h}_{m} {ρ}_{m} {c}_{m} + L {ρ}_{d} {c}_{d}} {T}_{0} = \frac{1}{1 + \frac{\sqrt{{χ}_{d} t} {ρ}_{d} {c}_{d}}{{h}_{m} {ρ}_{m} {c}_{m}}} {T}_{0} , \qquad ( 6 )$$

where and ρ_{m,d} and c_{m,d} are the density and specific heat of metal film 11 and dielectric 12, respectively, and χ_{d} is the thermal diffusivity of the dielectric 12. From equation (6), ½ decay time is found to be:
τ₃˜(ρₘcₘhₘ)²/χ_{d}(ρ_{d}c_{d})². (7)
At large times t>>τ₃ the temperature will decay as t^{-1/2}.

If the dielectric 12 thickness is much smaller compared to the metal film 11, the situation is different. Due to high thermal conductivity of the silicon substrate 13, the temperature rise at the dielectric 12/silicon 13 interface can be assumed to be zero. The heat flow through the dielectric 12 is equal to the product of the thermal conductivity of the dielectric k_{d}=ρ_{d}c_{d}χ_{d} and temperature gradient across the dielectric layer 12, i.e. T/h_{d}, where T is the temperature rise in the metal film 11 and h_{d} is the dielectric 12 thickness. Temperature dynamics of the metal film 11 is described by the equation

$${h}_{m} {ρ}_{m} {c}_{m} \frac{\partial T}{\partial t} = - {ρ}_{d} {c}_{d} {χ}_{d} \frac{T}{{h}_{d}} \qquad ( 8 )$$

yielding an exponential thermal decay,
T=T₀exp(−t/τ₃), (9)
with a decay time given by
τ₃=(ρₘcₘhₘh_{d})/(ρ_{d}c_{d}χ_{d}), (10)

Note that in both cases τ₃ is highly sensitive to the metal 11 thickness while τ₂ is independent of it. Therefore, the most favorable situation for metal 11 thickness measurement via thermal decay is the one when the vertical heat transport 211 dominates i.e. τ₃<<τ₂. This can be achieved either by using a large excitation spot (see an estimate below) or by measuring isolated test structures smaller than the excitation spot size. If τ₂ and τ₃ are comparable, the measurement is possible but the mathematical model used for signal analysis must take into account the lateral heat transport 111 and use the spot size as one of the model parameters. Finally, if τ₃>>τ₂, the measurement will be insensitive to the metal film 11 thickness.

As an example, quantitative estimates were performed for Cu films on thick silicon dioxide. According to equation (7), decay time τ₃ will vary between ˜50 ns and ˜5 μs as the film thickness increases from 0.1 to 1 μm. The “lateral” decay time τ₂ will be of the order of 20 μs for a ˜100 μm and ˜0.2 μs for a ˜10 μm. Thus the spot size of ˜10 μm will be too small to measure a micron-thick film but still adequate for a ˜0.1 μm-thick film, while ˜100 μm spot size will be adequate for an 1 μm-thick film.

Experiment

For the experimental verification of the proposed method, the excitation wavelength was 532 nm, pulse energy about 1 μJ, pulse duration ˜0.5 ns, spot size 200×40 μm. The probe wavelength was 830 nm, spot size 30×15 μm, and the probe power ˜1 μW. The small probe power led to a low signal level and required averaging over 4800 laser shots. An increase of the probe power to e.g. −1 mW will allow to obtain signals of similar quality with just a few laser shots, or increase the signal-to-noise ratio with more averaging.

Measurements were performed on TiN films which yielded good thermoreflectance signals at the probe wavelength 830 nm. A shorter probe wavelength would be better for measurements on copper.

Four samples with TiN films of thickness 500, 750, 1000 and 1500 Å deposited on 1000 Å of thermal oxide on silicon wafers were used. FIG. 2 depicts a chart showing the thermoreflectance transients obtained from the four samples. The horizontal axis of FIG. 2 corresponds to time in ns, and the vertical axis of FIG. 2 corresponds to reflectivity change in arbitrary units. Curves 21, 22, 23, and 24 correspond to the samples with TiN thickness 500, 750, 1000 and 1500 Å, respectively. The negative sign of the signals indicates that reflectivity of TiN at 830 nm decreases with temperature. As expected, the decay is slower for thicker samples. Note that two thicker samples 23, 24 yield a faster transient at the beginning of the signal. This can be ascribed to the relaxation across the film thickness described by decay time τ₁, which, in this case, will be longer than the estimated time for Cu films because of lower thermal diffusivity of TiN.

FIG. 3 presents a chart showing the dependence of the effective thermal decay time on the film 11 thickness. The horizontal axis of FIG. 3 corresponds to TiN thickness in angstroms, and the vertical axis of FIG. 3 corresponds to time in ns. The effective decay time was measured by fitting the signal waveforms to an exponential function within a time window from 15 to 50 ns. The points on the graph fall into a smooth curve 31 which shows that the measurements are well suited for the film thickness determination.

The preceding expressions and examples are exemplary and are not intended to limit the scope of the claims that follow.

1. A method for measuring the thickness of a film comprising:
impulsively irradiating a surface of the film with an excitation pulse to cause a rise in temperature in the film;
irradiating the surface of the film with a probe beam, such that it reflects off the surface of the film to generate a reflected probe beam; detecting a time-dependent variation in intensity of the reflected probe beam;
generating a signal waveform based on the measured variation in intensity;
determining the thickness of the film based on the signal waveform.

2. The method of claim 1, wherein the step of irradiating the surface of the film with a probe beam further comprises continuous irradiation.

3. The method of claim 1, wherein the step of irradiating the surface of the film with a probe beam further comprises quasi-continuous irradiation.

4. The method of claim 1, wherein the detecting step further comprises detecting variations that comprises a time domain temperature response to the excitation pulse.

5. The method of claim 1, wherein the determining step further comprises analyzing the signal waveform with a mathematical model.

6. The method of claim 5, wherein the mathematical model is derived based upon the optical constants of the film and thermal properties of the material or materials of which compose the film.

7. The method of claim 1, wherein the determining step further comprises analyzing the signal waveform with an empirical calibration.

8. The method of claim 1, wherein the measuring and generating steps are performed by a high-speed detector and a transient digitizer such as an oscilloscope.

9. The method of claim 1, wherein the step of impulsively irradiating a surface of the film with an excitation pulse further comprises an excitation spot size greater than 10 μm.

10. The method of claim 1, where the method measures patterned metal/dielectric structures with a feature size either larger or smaller than the excitation or probe spot size.

11. The method of claim 1, wherein the method measures isolated test structures either larger or smaller than a spot size of the excitation pulse.

12. An apparatus for measuring the thickness of a film comprising:
a single irradiating means for irradiating a single impulsive excitation beam to cause a rise in temperature in the film;
irradiating means for irradiating the surface of the film with a continuous probe beam, such that it reflects off the surface of the film to generate a reflected probe beam;
a high speed photodetector for detecting and measuring a time-dependent variation in intensity of the reflected probe beam corresponding to the at the surface of the thin film;
a transient digitizer such as an oscilloscope for generating a signal waveform based on the measured variations in intensity;
a computer for determining the thickness of the film based on the signal waveform.

13. The apparatus of claim 12, wherein the irradiating means for irradiating a single impulsive excitation beam further comprises a laser.

14. The apparatus of claim 13, wherein said laser emits pulses less than 10 ns in duration.

15. The apparatus of claim 12, wherein the irradiating means for irradiating the surface of the film with a probe beam comprises a laser.

16. The apparatus of claim 12, wherein the said probe beam is a continuous beam.

17. The apparatus of claim 12, wherein the said probe beam is a pulsed beam with the pulse duration longer than 10 ns.
